(19) United States
(12) Patent Application Publication
(10) Pub. No.: US 2025/0072319 A1
(43) Pub. Date: Mar. 6, 2025

(54) GROUND FOLLOWING TRIMMER

(71) Applicant: MTD PRODUCTS INC, Valley City, OH (US)

(72) Inventor: Jay Maggard, Polk, OH (US)

(21) Appl. No.: 18/816,704

(22) Filed: Aug. 27, 2024

Related U.S. Application Data
(60) Provisional application No. 63/535,168, filed on Aug. 29, 2023.

(51) Int. Cl. A01D 34/06; A01D 34/26

(52) U.S. Cl. CPC A01D 34/06; A01D 34/26

(57) ABSTRACT

Provided is a ground following trimmer having a frame, a trimmer, and a height adjustment suspension. The trimmer extends between the frame right side and the frame left side. The height adjustment suspension has a slider-crank mechanism engaged with the frame and having a crank and a slider. The crank defines a height adjustment axis about which the crank is rotatably engaged to the frame, and a roller axis offset from the height adjustment axis by a fixed crank distance. The slider has a first slider end engaged to the frame, and a second slider end engaged to the crank to transmit work from the slider to the crank to rotate the crank with respect to the frame about the height adjustment axis. Rotation of the crank about the height adjustment axis changes the position of the roller axis in the height direction.

### CROSS-REFERENCE TO RELATED APPLICATION

This application claims the benefit of U.S. Provisional Application No. 63/535,168, filed Aug. 29, 2023, the entirety of which is hereby incorporated by reference.

### FIELD OF DISCLOSURE

The disclosed subject matter generally pertains to apparatuses for power equipment for outdoor maintenance applications. More specifically, the disclosed subject matter pertains to apparatuses for performing mowing operations related to a trimmer adapted to be ground following.

### BACKGROUND AND SUMMARY

Manufacturers of power equipment for outdoor maintenance applications (e.g., mowers or trimmers) offer many types of machines for general maintenance and mowing applications. Generally, these machines can have a variety of forms depending on application, from general urban or suburban lawn maintenance, rural farm and field maintenance, to specialty applications. Even specialty applications can vary significantly.

Conventional fixed decks for mowers have a frame which fixes one or more mowing heads in both position and orientation with respect to the frame and to one another. For applications involving mowing over an uneven surface, alternatively referred to hereafter as a contoured ground, as a conventional deck moves over the uneven surface a suspension for one or more wheels allows the deck to comply with the surface up to a limit defined in part by the size of the deck. As decks become larger, it is more difficult for the suspension to provide effective compliance with smaller features of the uneven ground such that small bumps or grooves fall between the suspension elements and are not complied with. Failure to comply with ground features may lead to scalping or otherwise incorrect mow height or other improper or undesirable mowing results. Accordingly, it is sometimes desirable to provide a mow deck adapted to comply with contoured ground.

It is sometimes desirable to attach a trimmer to a mower to trim a region adjacent to or nearby a region to be mowed. Where the mower has a mow deck adapted to comply with contoured ground, it is desirable to have a trimmer that also is adapted to comply with contoured ground.

It remains desirable to develop a trimmer adapted to comply with contoured ground.

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure relate to a trimmer adapted to follow the ground and a method of using the same.

Provided in a first aspect is a ground following trimmer that has a frame, a trimmer, and a height adjustment suspension. The trimmer extends between the frame right side and the frame left side. The height adjustment suspension has a slider-crank mechanism engaged with the frame and having a crank and a slider. The crank defines a height adjustment axis about which the crank is rotatably engaged to the frame, and a roller axis offset from the height adjustment axis by a fixed crank distance. The slider has a first slider end engaged to the frame, and a second slider end engaged to the crank to transmit work from the slider to the crank to rotate the crank with respect to the frame about the height adjustment axis. Rotation of the crank about the height adjustment axis changes the position of the roller axis in the height direction.

In some optional embodiments of the above first aspect, the height adjustment axis is substantially parallel to the width direction. In some optional embodiments of the latter embodiment, the roller axis is substantially parallel to the width direction. Some optional embodiments of the latter embodiment further comprise a roller operationally engaged with the slider-crank mechanism to rotate about the roller axis and to provide support to the trimmer above a surface as it moves over the surface. In some optional embodiments of the latter embodiment, the crank further defines a slider input axis offset from the height adjustment axis by a second fixed crank distance. In some optional embodiments of the latter embodiment, the second slider end is operatively engaged to the crank at the slider input axis. In some optional embodiments of the latter embodiment, the slider input axis is substantially parallel to the width direction. In some optional embodiments of the latter embodiment, the first trimmer blade set comprises at least one trimmer blade adapted to operate by reciprocating motion along a first reciprocation axis. In some optional embodiments of the latter embodiment, the first reciprocation axis is substantially parallel to the width direction. In some optional embodiments of the latter embodiment, the slider comprises a spring.

Provided in a second aspect is a method of mowing using a ground following trimmer. The latter method comprises providing a ground following trimmer, moving the ground following trimmer over the surface to be mowed, and operating the first trimmer blade set of the trimmer to mow a mowable material as the ground following trimmer moves over the surface. The ground following trimmer may have a frame; a first trimmer blade set extending between the frame right side and the frame left side; and a height adjustment suspension. The height adjustment suspension may have a slider-crank mechanism engaged with the frame and a roller operationally engaged with the slider-crank mechanism to rotate about the roller axis and to provide support to the trimmer above the surface as it moves over the surface. The slider-crank may have a crank defining a height adjustment axis about which the crank is rotatably engaged to the frame, and a roller axis offset from the height adjustment axis by a first fixed crank distance. The slider crank may further have a slider having a first slider end operatively engaged to the frame and a second slider end operatively engaged to the crank to transmit work from the slider to the crank to rotate the crank with respect to the frame about the height adjustment axis. Rotation of the crank about the height adjustment axis changes the position of the roller axis with respect to the frame in at least the height direction.

In some optional embodiments of the above second aspect, the height adjustment axis is substantially parallel to the width direction. In some optional embodiments of the latter embodiment, the crank further defines a slider input axis offset from the height adjustment axis by a second fixed crank distance. In some optional embodiments of the latter embodiment, the slider input axis is substantially parallel to the width direction. In some optional embodiments of the latter embodiment, the first trimmer blade set comprises at least one trimmer blade adapted to operate by reciprocating motion along a first reciprocation axis. In some optional embodiments of the latter embodiment, the first reciprocation axis is substantially parallel to the width direction. In some optional embodiments of the latter embodiment, the slider comprises a spring. In some optional embodiments of the latter embodiment, the spring is operatively engaged between the slider input axis and an adjustment feature.

Provided in a third aspect is a ground following trimmer, comprising a frame, a first trimmer blade set, a height adjustment suspension. In this third aspect, the frame defines a frame right side and a frame left side opposite from the frame right side and offset in a width direction by a frame width; a frame front and a frame back opposite from the frame front and offset in a depth direction by a frame depth; and a frame top and a frame bottom opposite from the frame top and offset in a height direction by a frame height. In this third aspect, the first trimmer blade set extends between the frame right side and the frame left side; and has a first trimmer blade adapted to operate by reciprocating motion along a first reciprocation axis that is substantially parallel to the width direction. In this third aspect, the height adjustment suspension has a slider-crank mechanism engaged with the frame and a roller operationally engaged with the slider-crank mechanism. The slider-crank mechanism has a crank and a slider. The crank defines a height adjustment axis about which the crank is rotatably engaged to the frame, the height adjustment axis being substantially parallel to the width direction; a roller axis offset from the height adjustment axis by a first fixed crank distance, the roller axis being substantially parallel to the width direction; and, a slider input axis offset from the height adjustment axis by a second fixed crank distance, the slider input axis being substantially parallel to the width direction. The slider has a first slider end operatively engaged to the frame through an adjustment feature; and a second slider end operatively engaged to the crank at the slider input axis to transmit work from the slider to the crank to rotate the crank with respect to the frame about the height adjustment axis. The roller is operationally engaged with the slider-crank mechanism to rotate about the roller axis and to provide support to the trimmer above a surface as the trimmer moves over the surface. In this third aspect, rotation of the crank about the height adjustment axis changes the position of the roller axis with respect to the frame in at least the height direction. In this third aspect, the slider has a spring.

In some optional embodiments of the above third aspect, the ground following trimmer further comprises a mount adapted to operationally engage the ground following trimmer to an associated mower. In some optional embodiments of the latter embodiment, the adjustment feature is adapted to be threadedly adjusted. In some optional embodiments of the latter embodiment, the ground following trimmer further comprises a second trimmer blade set extending between the frame right side and the frame left side. In some optional embodiments of the latter embodiment, the second trimmer blade is adapted to operate by reciprocating motion along a second reciprocation axis that is substantially parallel to the width direction and offset from the first reciprocation axis in the depth direction. In some optional embodiments of the latter embodiment, the second reciprocation axis is offset from the first reciprocation axis in the height direction. In some optional embodiments of the latter embodiment, the slider further comprises a damper.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 shows a perspective view of a first embodiment of a ground following trimmer.

FIG. 2 shows a perspective view of the first embodiment of a ground following trimmer.

FIG. 3 shows a perspective view of the first embodiment of a ground following trimmer.

FIG. 4 shows a perspective view of the first embodiment of a ground following trimmer.

FIG. 4A shows a close-up of a part of the perspective view of the first embodiment of a ground following trimmer of FIG. 4

FIG. 5 shows a perspective view of the first embodiment of a ground following trimmer.

FIG. 5A shows a close-up of a part of the perspective view of the first embodiment of a ground following trimmer of FIG. 5

FIG. 6 shows a perspective view of the first embodiment of a ground following trimmer.

FIG. 7 shows a perspective view block diagram of a frame of a ground following trimmer.

FIG. 8 shows a schematic view of a slider-crank mechanism.

FIG. 9 shows a close up of an embodiment of a grooming wheel.

FIG. 10 shows another view of the embodiment of a grooming wheel of FIG. 9.

FIG. 11 shows a front perspective view of another embodiment of a ground following trimmer.

FIG. 12 shows another front perspective view of the ground following trimmer of FIG. 11.

FIG. 13 shows another front perspective view of the ground following trimmer of FIG. 11.

FIG. 14 shows a schematic of some components of a ground following trimmer.

It should be noted that the drawings not drawn to scale. Relative dimensions and proportions of parts of the figures may be shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to a ground following trimmer are described herein, it should be understood that the disclosed apparatuses and methods are not so limited, and modifications may be made without departing from the scope of the present disclosure. The scope of the systems, methods, and apparatuses are defined by the appended claims, and all devices, processes, and methods that come within the meaning of the claims, either literally or by equivalence, are intended to be embraced therein.

### DETAILED DESCRIPTION

Various embodiments can comprise a ground following trimmer according to various aspects discussed herein. As used herein, a ground following trimmer may be referred to as part of an associated mower, but it is understood that the term “mower” is not limiting and that other powered equipment other than mowers for moving over and operating upon a surface are also contemplated. A ground following trimmer can be engaged with an associated walk-behind mower or an associated ride-on mower of any of a variety of configurations, such as an associated seated mower, an associated standing mower, or an associated convertible seated/standing mower.

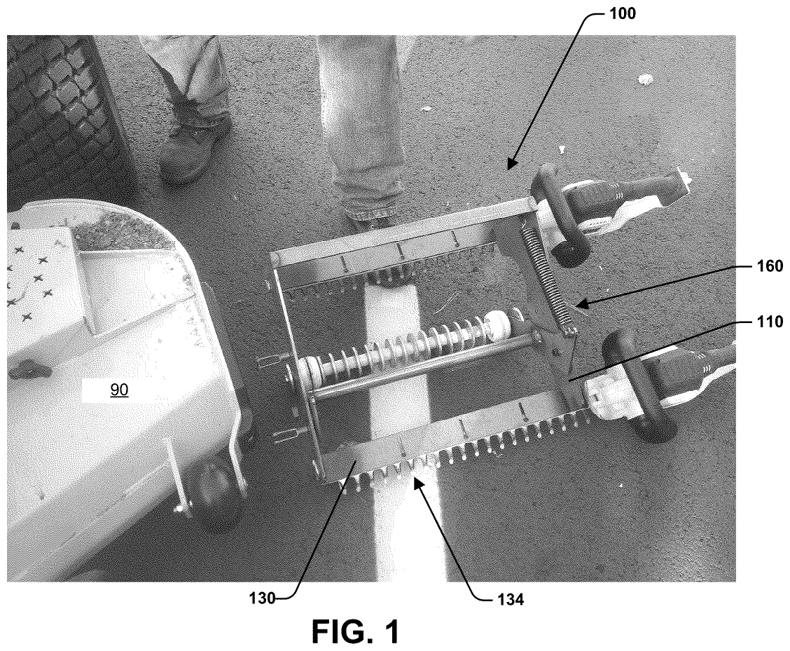

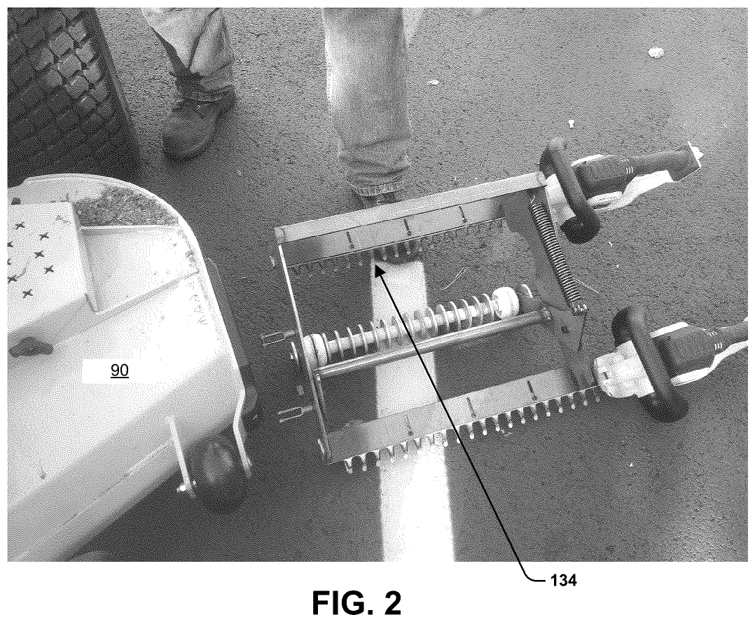

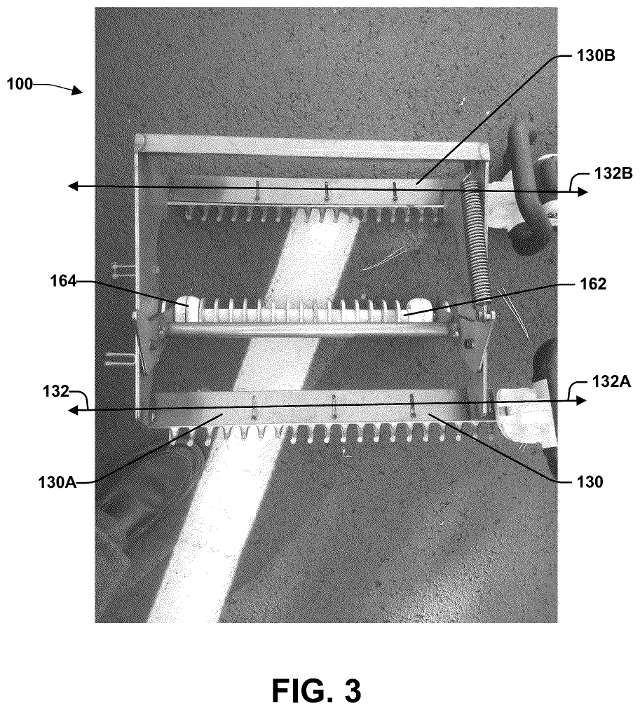

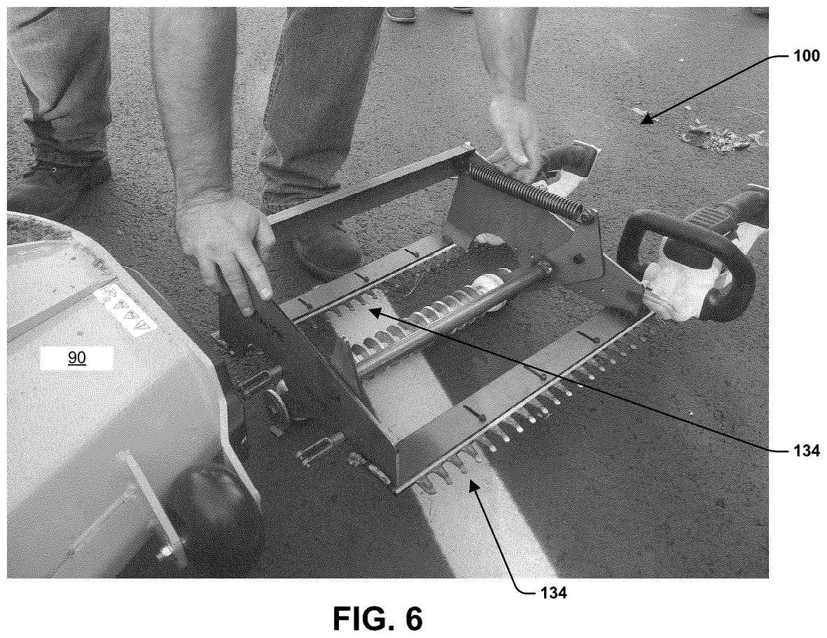

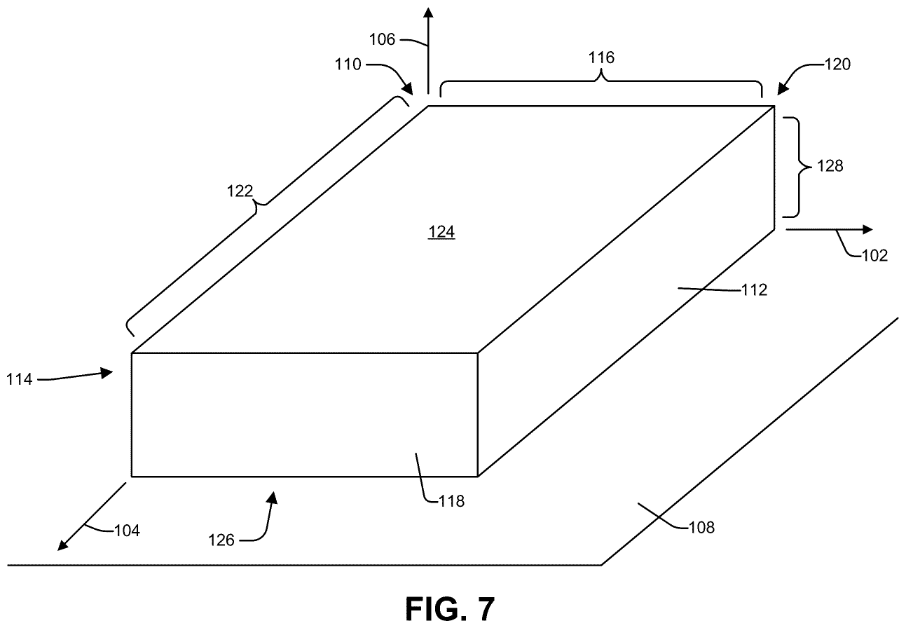

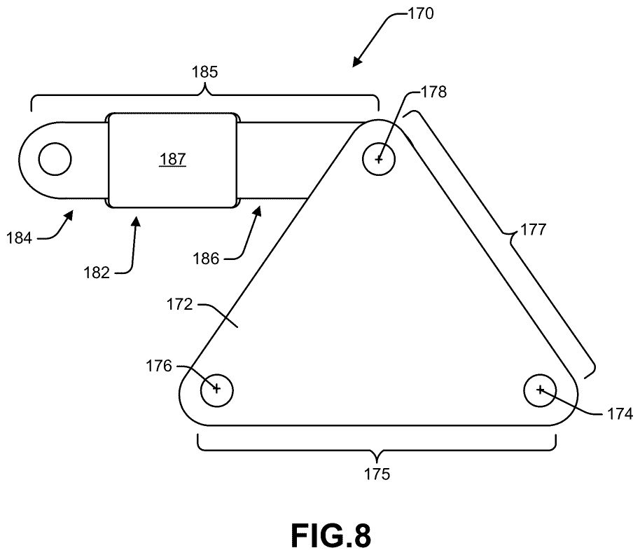

FIGS. 1-8 show a first non-limiting aspect of a ground following trimmer 100 employable as or in connection with various embodiments of the present disclosure. In the non-limiting embodiment shown in FIGS. 1-2, and 4-6, ground following trimmer 100 is shown engaged with an associated mower 90.

With continued reference to FIGS. 1-8, ground following trimmer 100 comprises a frame 110, a trimmer blade set 130, and a height adjustment suspension 160.

The frame 110 has a frame right side 112 and a frame left side 114 opposite from the frame right side 112 and offset in a width direction 102 by a frame width 116. The frame 110 has a frame front 118 and a frame back 120 opposite from the frame front 118 and offset in a depth direction 104 by a frame depth 122. The frame 110 has a frame top 124 and a frame bottom 126 opposite from the frame top 124 and offset in a height direction 106 by a frame height 128. The frame 110 provides a substantially rigid structure that is adapted to hold other components of the ground following trimmer 100 fixedly engaged therewith in a desired position and orientation with respect to the frame 110. Herein, substantially rigid means that the structure or component in question will remain within an operationally trivial spatial range of its design geometry under all operational conditions. Here it is to be understood that operationally trivial means that any deviation from the design geometry does not adversely affect the quality of the mowing operation in a way that is deemed important using good engineering judgment. In some aspects, that operationally trivial amount is no more than 4 mm or 4 degrees from the design geometry. In some aspects, that operationally trivial amount is no more than 2 mm or 2 degrees from the design geometry. In some aspects, that operationally trivial amount is no more than 1 mm or 1 degree from the design geometry. In the non-limiting embodiment shown in FIGS. 1-6, the frame 110 is composed of steel plates welded to one another. In other acceptable embodiments the structural components of the frame may comprise metal tubes, metal structural angles, cast components, extruded components, molded components, or otherwise as chosen with good engineering judgment. In other acceptable embodiments, the structural components of the frame may comprise steel alloy, aluminum alloy, magnesium alloy, injection molded polymers, or otherwise as chosen with good engineering judgment. The frame components may be joined by welding, brazing, soldering, mechanical fasteners, adhesives, or otherwise as chosen with good engineering judgment.

The trimmer blade set 130 extends between the frame right side 112 and the frame left side 114. In some embodiments, the trimmer blade set 130 is the only blade set, but in other acceptable embodiments there may be multiple blade sets with the trimmer blade set 130 being the first trimmer blade set 130A and with there further being one or more other trimmer blade sets including a second trimmer blade set 130B. In some non-limiting embodiments, the trimmer blade set 130 is adapted to operate by reciprocating motion along a reciprocation axis 132. A trimmer blade set 130 may comprise one or more blades 134 extending substantially perpendicularly to the reciprocation axis 132 and adapted to be operated to make a cutting motion substantially perpendicular to the reciprocation axis 132 in order to cut a mowable material. As used herein, substantially perpendicularly and substantially perpendicular means that the orientations in question are within an operationally trivial spatial range from perpendicular. Here it is to be understood that operationally trivial means that any deviation from the nominal orientation does not adversely affect the quality of the operation in a way that is deemed important using good engineering judgment. In some aspects, that operationally trivial amount is no more than 4 mm or 4 degrees from the nominal perpendicular position and orientation. In some aspects, that operationally trivial amount is no more than 2 mm or 2 degrees from the nominally perpendicular position and orientation. In some aspects, that operationally trivial amount is no more than 1 mm or 1 degree from the nominally perpendicular position and orientation. In some non-limiting embodiments, the reciprocation axis 132 of trimmer blade set 130 is substantially parallel to the width direction. As used herein, substantially parallel means that the orientations in question are within an operationally trivial spatial range from parallel. Here it is to be understood that operationally trivial means that any deviation from the nominal orientation does not adversely affect the quality of the operation in a way that is deemed important using good engineering judgment. In some aspects, that operationally trivial amount is no more than 4 mm or 4 degrees from the nominal parallel position and orientation. In some aspects, that operationally trivial amount is no more than 2 mm or 2 degrees from the nominally parallel position and orientation. In some aspects, that operationally trivial amount is no more than 1 mm or 1 degree from the nominally parallel position and orientation. In the non-limiting embodiments shown in FIGS. 1-8, there is a first trimmer blade set 130A extending along a first reciprocation axis 132A extending parallel to the width direction and at a first height position and at a first depth position, and there is a second trimmer blade set 130B extending along a second reciprocation axis 132B extending parallel to the width direction and at a second height position different from the first height position and at a second depth position different from the first depth position.

In those optional embodiments with multiple trimmer blade sets, each trimmer blade set may have an operational frequency, amplitude, and phase shift. In some embodiments, each trimmer blade set will have the same operational frequency, amplitude, and phase shift as each other trimmer blade set. In other acceptable embodiments, each blade set may have a particular operational frequency, amplitude, and phase shift and the operational frequency, amplitude, and phase shift of a trimmer blade set may or may not differ from that of any other trimmer blade set. In some embodiments in which vibration or noise is of concern, the operational frequency, amplitude, and phase shift of a multiple trimmer blade sets may be chosen such that the dynamic forces along their reciprocation axes are in or are close to destructive interference. For example and not by way of limitation, in some embodiments in which vibration or noise is of concern, the operational frequency, amplitude, and phase shift of a first trimmer blade set 130A and the operational frequency, amplitude, and phase shift of a second trimmer blade set 130B may be chosen such that the dynamic forces along the reciprocation axis 132A resulting from operation of first trimmer blade set 130A are of substantially the same magnitude but opposite direction to that of the dynamic forces along the reciprocation axis 132B resulting from operation of second trimmer blade set 130B. It is to be understood that a controller may be used to actively modify the operational frequency and amplitude of a trimmer blade set while mowing.

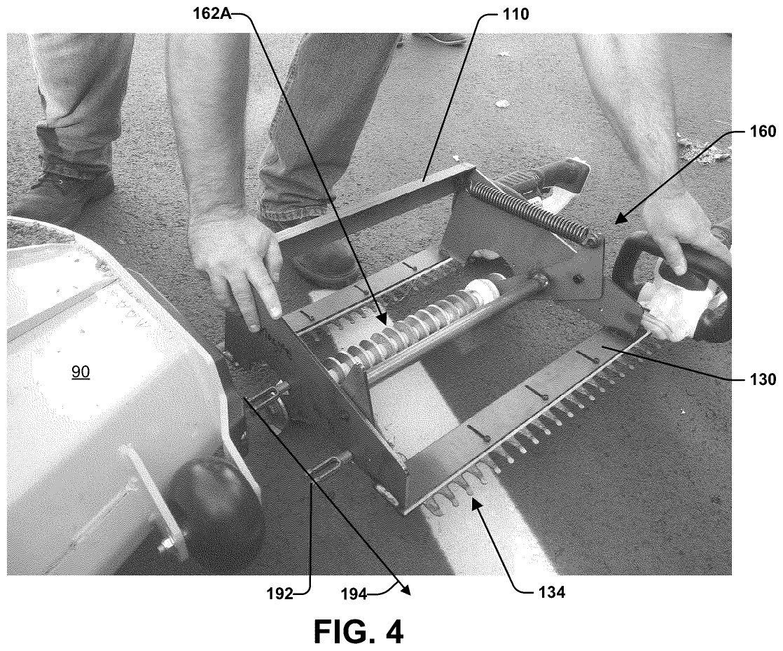

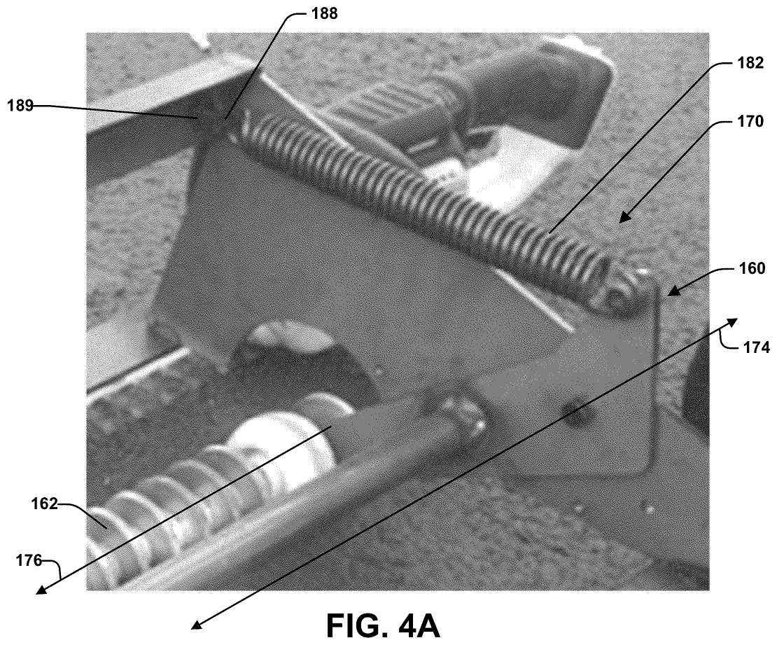

With continued reference to FIGS. 1-8, and with particular reference to FIGS. 4A, 5A, and 8, the height adjustment suspension 160 comprises a slider-crank mechanism 170 engaged with the frame 110 and a roller 162. The slider-crank mechanism has a crank 172 and a slider 182.

The crank 172 defines a height adjustment axis 174 and a roller axis 176. In some embodiments, the crank 172 may optionally further define a slider input axis 178. The crank 172 is rotatably engaged to the frame 110 at the height adjustment axis 174. In the embodiment shown, the crank 172 comprises a steel plate, but any composition and design chosen with a good engineering judgment that holds the axes defined thereby in a substantially fixed location and orientation with respect to one another would be acceptable. As used herein, substantially fixed, means that the location and orientation in question are within an operationally trivial spatial range from the nominal location and orientation. Here it is to be understood that operationally trivial means that any deviation from the nominal location and orientation does not adversely affect the quality of the operation in a way that is deemed important using good engineering judgment. In some aspects, that operationally trivial amount is no more than 4 mm or 4 degrees from the nominal location and orientation. In some aspects, that operationally trivial amount is no more than 2 mm or 2 degrees from the nominal location and orientation. In some aspects, that operationally trivial amount is no more than 1 mm or 1 degree from the nominal location and orientation. The height adjustment axis 174 may extend between the frame right side 112 and the frame left side 114. In some embodiments, the height adjustment axis 174 may be substantially parallel to the width direction 102. The roller axis 176 is offset from the height adjustment axis 174 by a first fixed crank distance 175. The roller axis 176 may extend between the frame right side 112 and the frame left side 114. In some embodiments, the roller axis 176 may be substantially parallel to the height adjustment axis 174. In some embodiments, the roller axis 176 may be substantially parallel to the width direction 102. In those embodiments in which the crank 172 defines a slider input axis 178, the slider input axis 178 may be offset from the height adjustment axis 174 by a second fixed crank distance 177. The slider input axis 178 may extend between the frame right side 112 and the frame left side 114. In some embodiments, the slider input axis 178 may be substantially parallel to the height adjustment axis 174. In some embodiments, the slider input axis 178 may be substantially parallel to the width direction 102.

The slider 182 has a first slider end 184 and a second slider end 186 offset from the first slider end 184 by a slider length 185. It should be understood that the slider length 185 is not fixed and changes during operation of the slider-crank mechanism 170. The first slider end 184 is operatively engaged to the frame 110. The first slider end 184 may be engaged to the frame 110 at a fixed location or it may optionally be engaged to the frame 110 in a manner that permits the location to be adjusted. In the embodiment shown in FIGS. 1-8 and with particular reference now to FIG. 4A, shown is an optional adjustment feature 189. The optional adjustment feature 189 holds the first slider end 184 operatively engaged to the frame 110 at an adjustable location 188 selectable by an associated user. In the non-limiting embodiment shown in FIG. 4A the adjustment feature 189 is an eye-screw and nut pair threadedly engaged between the frame 110 and the first slider end 184 such that the adjustment feature 189 is adapted to be threadedly adjusted to move the adjustable location 188 with respect to the frame 110. Other forms of adjustment feature are contemplated such as a feature having a cam or lever adjustable to move the adjustable location 188 with respect to the frame 110. The second slider end 186 is operatively engaged to the crank 172 to transmit work from the slider 182 to the crank 172 to rotate the crank 172 with respect to the frame 110 about the height adjustment axis 174. In some embodiments the second slider end 186 may be operatively engaged to the crank 172 at the slider input axis 178. In the embodiments shown in FIGS. 1-8, the slider 182 comprises an extension spring but other components are contemplated in addition to or in the alternative to an extension spring including but not limited to a compression spring, a gas spring, a torsion spring, a damper 187, an actuator, a combination thereof, or otherwise as chosen with good engineering judgment.

The roller 162 is operationally engaged with the slider-crank mechanism 170 to rotate about the roller axis 176 and to provide support to the trimmer 100 above a surface 108 as the trimmer 100 moves over the surface 108 during a trimming operation. In the embodiment shown in FIGS. 1-8, the roller 162 comprises a set of wheels 164, but the roller 162 may comprise in addition to or in the alternative to wheels, a tire, a caster, or otherwise as chosen with good engineering judgment. Rotation of the crank 172 about the height adjustment axis 174 changes the position of the roller axis 176 with respect to the frame 110 in at least the height direction 106 and thereby changes the height above the surface 108 at which the roller 162 supports the trimmer 100 as it moves over the surface 108 during a trimming operation.

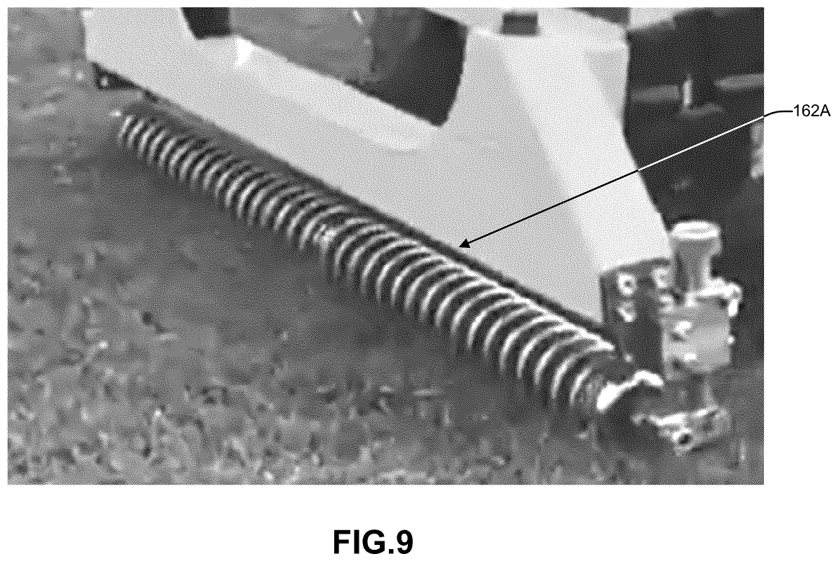

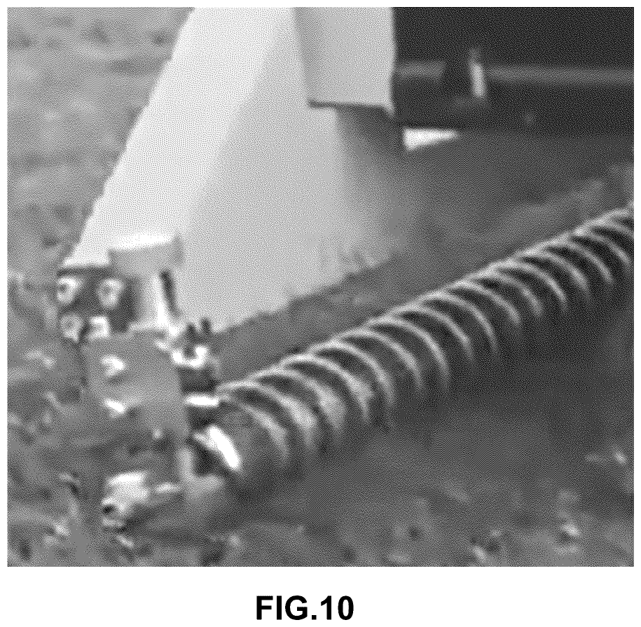

With continued reference to FIGS. 1-6 and with further reference now to FIGS. 9-10, in some non-limiting embodiments, roller 162 is a grooming roller 162A. A grooming roller 162A comprises one or more grooming disks 166 spaced apart from one another by a one or more grooming spacers 168. In some embodiments a grooming roller 162A may comprise an assembly of discrete grooming disks 166 and discrete grooming spacers 168, but in other acceptable alternatives, a grooming roller 162A may be a single unitary component or may otherwise be composed of subassemblies more complex than discrete grooming disks 166 and grooming spacers 168. In the embodiments shown in FIGS. 1-6 and 9-10, the roller 162 is a grooming roller 162A comprising a plurality of similar grooming disks 166 spaced apart from one another by a plurality of similar grooming spacers 168. In some non-limiting embodiments, the grooming disks 166 have varying geometry and shape, but in other non-limiting embodiments, the grooming disks 166 have similar geometry and shape. In some non-limiting embodiments, the grooming disks 166 each have a diameter within 25% of some nominal diameter. In some non-limiting embodiments, the grooming disks 166 each have a diameter that is substantially identical to some nominal diameter. Herein, substantially identical means that the dimensions in question are within an operationally trivial range. Here it is to be understood that operationally trivial means that any deviation from the nominal dimension does not adversely affect the quality of the mowing operation in a way that is deemed important using good engineering judgment. In some aspects, that operationally trivial amount is no more than 4 mm or 4 degrees from the nominal dimension. In some aspects, that operationally trivial amount is no more than 2 mm or 2 degrees from the nominal dimension. In some aspects, that operationally trivial amount is no more than 1 mm or 1 degree from the nominal dimension. In some non-limiting embodiments, the grooming disks 166 are each thin cylinders having a diameter D1 and a thickness T1 mounted between grooming spacers 168 having a diameter D2 and a thickness T2 where D2 is between 10% of D1 and 90% of D1, inclusive, and T2 is between 50% or T1 and 600% of T1, inclusive. It should be understood that a grooming roller 162A which proceeds a blade in operation can act to groom the material to be mowed and provide a better mow performance than without use of same. While not wishing to be bound by any particular theory, a grooming roller 162A may improve mow performance by combing the material to be mowed and standing it up through friction at the trailing side of the grooming spacers 168.

With reference now to FIGS. 1-8, and with particular reference to FIG. 4, the trimmer 100 may, optionally, further comprise a mount 192 adapted to operationally engage the ground following trimmer 100 to an associated mower 90. In the non-limiting embodiments shown in FIGS. 1-8, the mount 192 is adapted to operationally engage the trimmer 100 with an associated mower such that the trimmer 100 is beside the mower during operation. In FIGS. 1-8, the mount 192 is shown to extend from a side of the trimmer 100 and to engage an associated side of an associated deck of an associated mower 90. This latter aspect is not limiting, and it is contemplated that other connections and engagement will also be acceptable. For example, the trimmer 100 may be engaged at the front of an associated mower. In FIGS. 1-8, the mount 192 is shown as adapted for a pin connection to the associated mower and the resulting engagement would, accordingly, be rotatable about the pin axis 194 of the pin. It is contemplated that the trimmer as engaged with the associated mower as shown in FIGS. 1-8, will be adapted to be selectably pivoted about the pin axis 194 by an associated user between the operational orientation shown in FIGS. 1-8, where it is deployed to mow, and a stowed orientation where it is upright. The latter adaptation for pin connection is not limiting and it is contemplated that other connections and engagement will also be acceptable. It should be further be understood that the ground following trimmer may be adapted as a stand-alone walk behind trimmer.

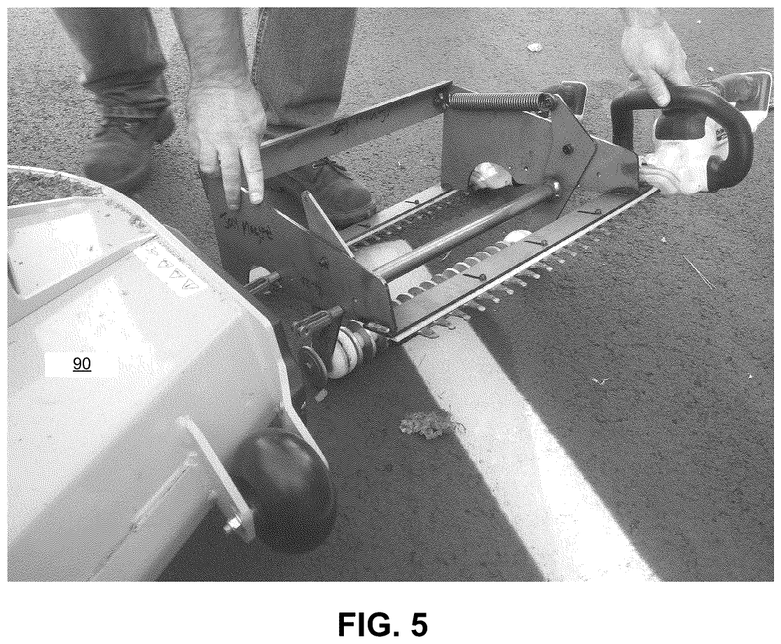

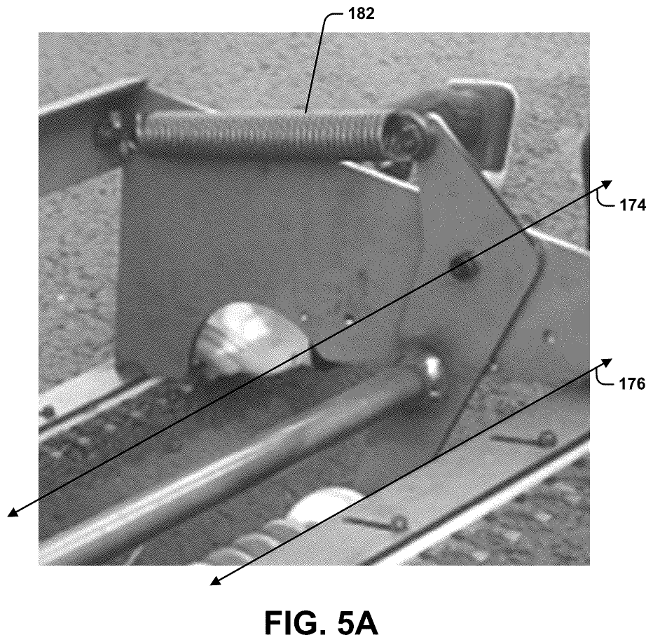

It should be understood that in embodiments in which the slider 182 comprises springs, the springs are adapted to store mechanical energy and provide a reaction force on the crank to promote rotation of the crank and displacement of the roller 162 downwardly against the surface 108. This can be seen in FIGS. 4-5A with particular reference to FIGS. 4A and 5A which show close up views of the slider-crank mechanism 170 in different operational configurations. FIG. 4 shows the trimmer 100 with an associated user applying a downward force on the trimmer 100 and has displaced the roller 162 upwardly with respect to frame 110 and caused the slider 182 to extend and store energy. In FIG. 5, the associated user has released the downward force on the trimmer 100 such that the slider 182 has contracted, released the stored energy, and rotated the crank to displace the roller 162 downwardly with respect to the frame 100. Other forces which act on the trimmer 100 may include the body force from the weight of the trimmer, the upward reaction force on the roller from the surface 108 and, the upward force on the trimmer from an associated mower through the mount 192. These forces collectively yield a net force on the trimmer which then results in resulting operating height of the trimmer above the surface 108. The operating height of the trimmer above the surface 108 may be adjusted by adjusting the above-recited forces. For example, an associated user could increase the operating height of the trimmer above the surface 108 by increasing the operating height of the mower and thereby increase the upward force on the trimmer from the associated mower through the mount 192. Similarly, an associated user could decrease the operating height of the trimmer above the surface 108 by decreasing the operating height of the mower and thereby decrease the upward force on the trimmer from the associated mower through the mount 192. Alternatively, a user could modify the above-recited forces by adjusting the adjustment feature 189.

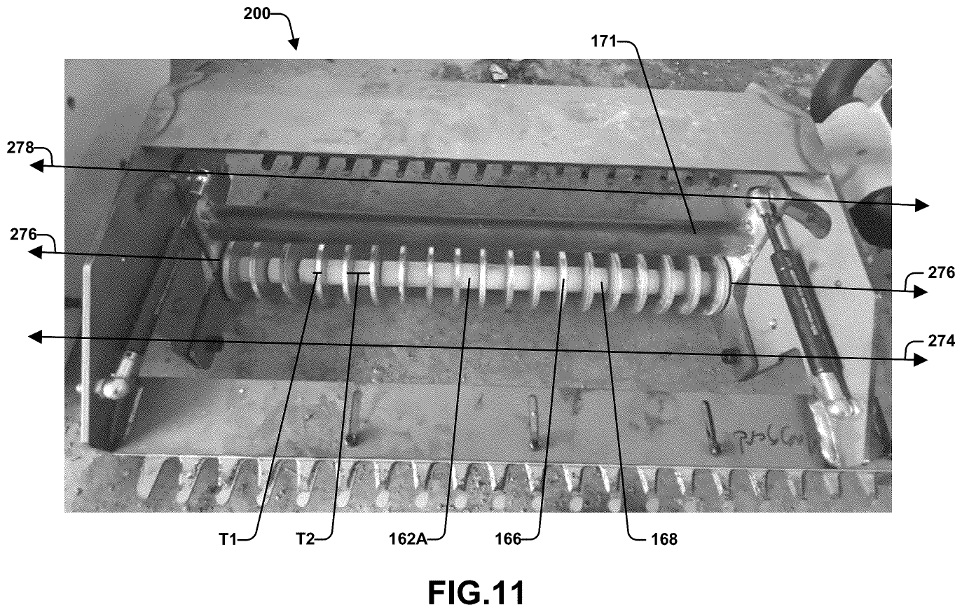

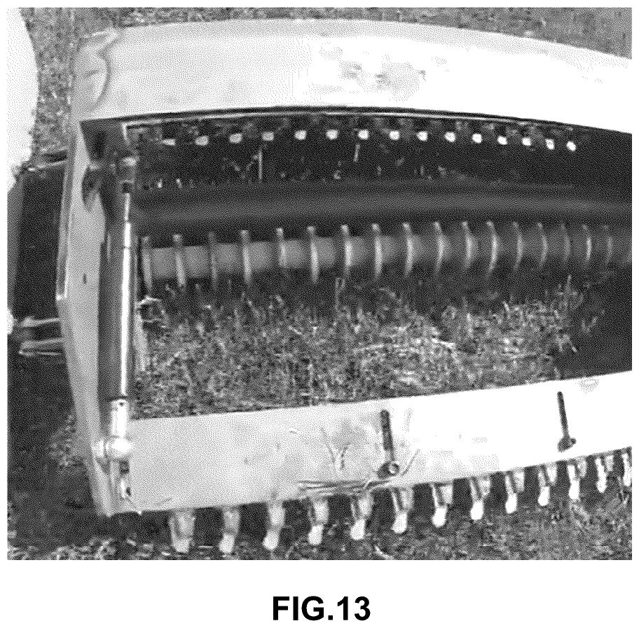

Referring now to FIGS. 11-13, shown is a non-limiting second embodiment of a ground following trimmer 200. Ground following trimmer 200 is generally similar to ground following trimmer 100 with a few differences which will be addressed herebelow. In ground following trimmer 200, the height adjustment suspension 160 comprises a first slider-crank mechanism 170 and also comprises a second slider-crank mechanism 270. The second slider-crank mechanism 270 will be generally a mirror image (as used here, a mirror image across an imaginary mirror plane parallel with and between frame right side 112 and frame left side 114) of the first slider-crank mechanism 170. The second slider-crank mechanism 270 has a crank 272 that is a mirror image of crank 172, and a slider 282 that is a mirror image of slider 182.

The crank 272 has a height adjustment axis 274 coincident with height adjustment axis 174 and a roller axis 276 coincident with roller axis 176. In the second embodiment, the crank 272 further defines a slider input axis 278 coincident with slider input axis 178. The crank 272 is rotatably engaged to the frame 110 on the frame left side 114 at the height adjustment axis 274 coincident with height adjustment axis 174. Crank 272 may be composed of the same material as that which crank 172 is composed of. The roller axis 276 is offset from the height adjustment axis 274 by the first fixed crank distance 175 by which roller axis 176 is offset from the height adjustment axis 174. The slider input axis 278 is offset from the height adjustment axis 274 by the second fixed crank distance 177 by which slider input axis 178 is offset from the height adjustment axis 174.

Extending between first slider-crank mechanism 170 and second slider-crank mechanism 270 is a torque bar 171. The torque bar 171 is engaged with the crank 172 and crank 272 such that the cranks rotate about the height adjustment axis 174 in unison. In some embodiments the torque bar 171 is an elongated steel bar welded between each crank but this is not limiting.

The slider 282 has a first slider end 284 and a second slider end 286 offset from the first slider end 284 by a slider length. It should be understood that the slider length is not fixed and changes during operation of the slider-crank mechanism 270. It should also be understood that in embodiments where it operates as part of ground following trimmer 200, due to the action of torque bar 171, the slider length may be held substantially identical to slider length 185 at any given time. In the second embodiment, the first slider end 284 is shown operatively engaged to the frame 110 at a fixed location 288. This operative engagement to the frame 110 at a fixed location 288 is one option and the alternative of engagement to the frame 110 at an adjustable location 188 selectable by an associated user as recited above is also contemplated.

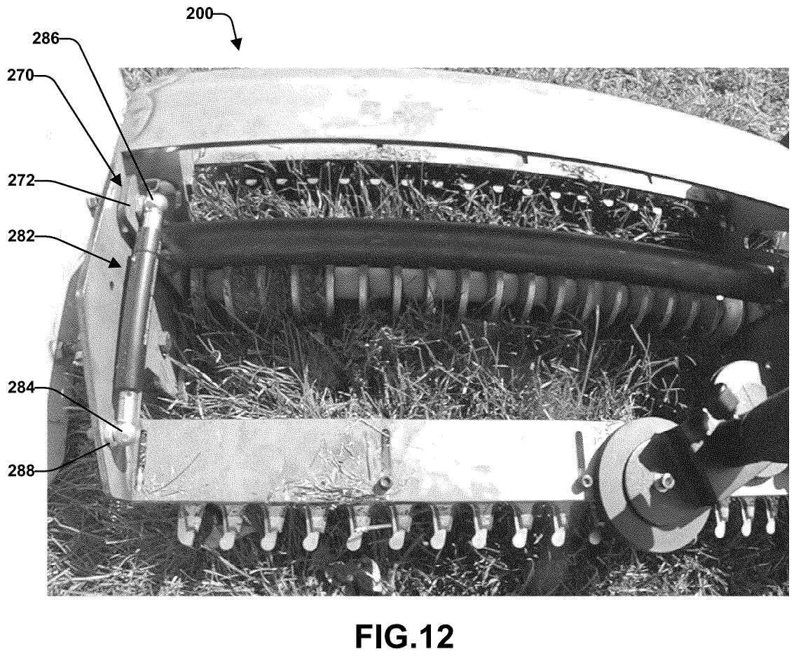

In operation of ground following trimmer 200, the second slider end 286 is operatively engaged to the crank 272 to transmit work from the slider 282 to the crank 272 to rotate the crank 272 with respect to the frame 110 about the height adjustment axis 274. In the embodiment shown the second slider end 286 is operatively engaged to the crank 272 at the slider input axis 278. In the embodiments shown in FIGS. 11-12, the slider 182 comprises a gas spring but other components are contemplated in addition to or in the alternative to a gas spring including but not limited to an extension spring, a compression spring, a gas spring, a torsion spring, a damper 187, an actuator, a combination thereof, or otherwise as chosen with good engineering judgment.

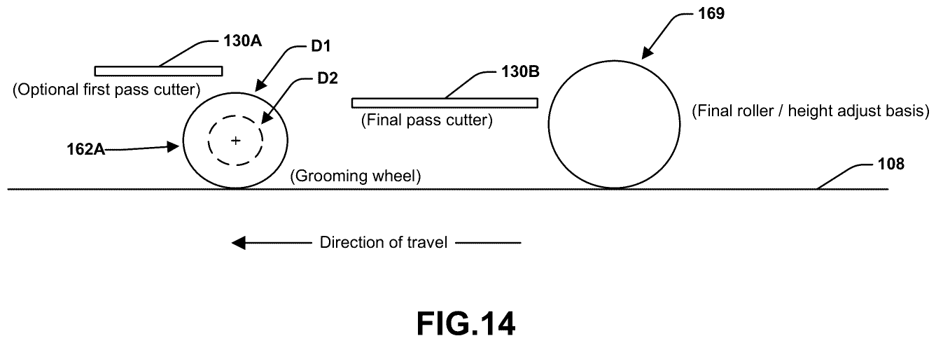

It should be understood the trimmer 100 and the trimmer 200 are non-limiting embodiments and that other embodiments with other features are also contemplated. Referring now to FIG. 14, embodiments with a plurality of rollers are contemplated. In some such embodiments, the trimmer may have a roller 162, which may optionally be a grooming roller 162A, as well as a final roller 169. It is further contemplated that, in some embodiments with a plurality of rollers, the rollers may all be operationally engaged with the same height adjustment suspension. It is further contemplated that, in some embodiments with a plurality of rollers, at least one roller may be operationally engaged with a first height adjustment suspension and at least one other roller may be operationally engaged with at least one other height adjustment suspension.

The above disclosed embodiments of a ground following trimmer may be used in a method of mowing using a ground following trimmer. A method of mowing using a ground following trimmer may comprise providing a ground following trimmer, moving the ground following trimmer over the surface to be mowed, and operating the first trimmer blade set to mow a mowable material as the ground following trimmer moves over the surface.

The ground following trimmer provided in the latter method may have a frame, a first trimmer blade set extending between the frame right side and the frame left side, and a height adjustment suspension. The height adjustment suspension may have a slider-crank mechanism engaged with the frame with the slider-crank having a crank defining a height adjustment axis about which the crank is rotatably engaged to the frame, a roller axis offset from the height adjustment axis by a first fixed crank distance, a slider having a first slider end operatively engaged to the frame, and a second slider end operatively engaged to the crank to transmit work from the slider to the crank to rotate the crank with respect to the frame about the height adjustment axis. The frame may define a frame right side and a frame left side opposite from the frame right side and offset in a width direction by a frame width, a frame front and a frame back opposite from the frame front and offset in a depth direction by a frame depth, and a frame top and a frame bottom opposite from the frame top and offset in a height direction by a frame height. In this ground following trimmer provided in the latter method, the rotation of the crank about the height adjustment axis changes the position of the roller axis with respect to the frame in at least the height direction. The ground following trimmer provided in the latter method, may further have a roller operationally engaged with the slider-crank mechanism to rotate about the roller axis and to provide support to the trimmer above a surface as it moves over the surface.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments.

As utilized herein, relative terms and terms of degree including the term “about”, “approximately”, “substantially”, “roughly”, “near” and others are intended to incorporate ranges and variations about a qualified term reasonably encountered by one of ordinary skill in the art in fabricating, compiling or optimizing the embodiments disclosed herein to suit design preferences, where not explicitly specified otherwise. When utilized to modify a numerical description of a disclosed element, a relative term can imply a suitable range about the given number. Any implied range is intended to be consistent with and achieve the same or similar functions as described for the disclosed structure given the numerical description, where applicable. Where such ranges are not explicitly disclosed, a range within typical manufacturing tolerances associated with suitable manufacturing equipment (e.g., injection molding equipment, extrusion equipment, metal stamping equipment, and so forth) understood by one of ordinary skill in the art for realizing an element from a disclosed illustration or description can be implied. In some embodiments, depending on context and the capabilities of one of ordinary skill in the art, relative terminology can refer to a variation in a disclosed value or characteristic; e.g., a zero to two or three-percent variance, a zero to five-percent variance or a zero to ten-percent variance from precise mathematically defined value or characteristic, or any suitable value or range there between can define a scope for a disclosed term of degree. As an example, a disclosed mechanical dimension can have a variance of suitable manufacturing tolerances as would be understood by one of ordinary skill in the art, or a variance of a few percent about the disclosed mechanical dimension that would achieve a stated purpose or function of the disclosed mechanical dimension. Relative terms utilized for qualitative (rather than quantitative) description can be understood to imply explicitly stated alternatives or variations, variations understood in the art to occur from manufacturing tolerances or variations in a manufacturing process, variations understood in the art to achieve the function or purpose described for a particular component or process, or a suitable combination of the foregoing.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”, so that usage of “or” can have the same meaning as “and/or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A ground following trimmer, comprising:
a frame defining a
a frame right side and a frame left side opposite from the frame right side and offset in a width direction by a frame width,
a frame front and a frame back opposite from the frame front and offset in a depth direction by a frame depth,
a frame top and a frame bottom opposite from the frame top and offset in a height direction by a frame height;
a first trimmer blade extending between the frame right side and the frame left side;
a height adjustment suspension having
a slider-crank mechanism engaged with the frame, the slider-crank mechanism having
a crank defining
a height adjustment axis about which the crank is rotatably engaged to the frame,
a roller axis offset from the height adjustment axis by a first fixed crank distance;
a slider having
a first slider end operatively engaged to the frame,
a second slider end operatively engaged to the crank to transmit work from the slider to the crank to rotate the crank with respect to the frame about the height adjustment axis; and
wherein rotation of the crank about the height adjustment axis changes the position of the roller axis with respect to the frame in at least the height direction.

2. The ground following trimmer of claim 1, further comprising a roller operationally engaged with the slider-crank mechanism to rotate about the roller axis and to provide support to the trimmer above a surface as it moves over the surface.

3. The ground following trimmer of claim 2, wherein the crank further defines a slider input axis offset from the height adjustment axis by a second fixed crank distance.

4. The ground following trimmer of claim 3, wherein the second slider end is operatively engaged to the crank at the slider input axis.

5. The ground following trimmer of claim 4, wherein the first trimmer blade comprises at least one trimmer blade adapted to operate by reciprocating motion along a first reciprocation axis.

6. The ground following trimmer of claim 5, wherein:
the height adjustment axis is substantially parallel to the width direction;
the roller axis is substantially parallel to the width direction;
the slider input axis is substantially parallel to the width direction; and
the first reciprocation axis is substantially parallel to the width direction.

7. The ground following trimmer of claim 6, wherein the slider comprises a spring.

8. A method of mowing using a ground following trimmer comprising,
providing a ground following trimmer having,
a frame defining a
a frame right side and a frame left side opposite from the frame right side and offset in a width direction by a frame width,
a frame front and a frame back opposite from the frame front and offset in a depth direction by a frame depth,
a frame top and a frame bottom opposite from the frame top and offset in a height direction by a frame height,
a first trimmer blade extending between the frame right side and the frame left side,
a height adjustment suspension having
a slider-crank mechanism engaged with the frame, the slider-crank having
a crank defining
a height adjustment axis about which the crank is rotatably engaged to the frame,
a roller axis offset from the height adjustment axis by a first fixed crank distance,
a slider having
a first slider end operatively engaged to the frame,
a second slider end operatively engaged to the crank to transmit work from the slider to the crank to rotate the crank with respect to the frame about the height adjustment axis,
wherein rotation of the crank about the height adjustment axis changes the position of the roller axis with respect to the frame in at least the height direction, and
a roller operationally engaged with the slider-crank mechanism to rotate about the roller axis and to provide support to the trimmer above a surface as it moves over the surface;
moving the ground following trimmer over the surface; and
operating the first trimmer blade to mow a mowable material as the ground following trimmer moves over the surface.

9. The method of mowing using a ground following trimmer of claim 8,
wherein the crank further defines a slider input axis offset from the height adjustment axis by a second fixed crank distance; and
wherein the second slider end is operatively engaged to the crank at the slider input axis.

10. The method of mowing using a ground following trimmer of claim 9, wherein the first trimmer blade comprises a first trimmer blade adapted to operate by reciprocating motion along a first reciprocation axis.

11. The method of mowing using a ground following trimmer of claim 10, further comprising a second trimmer blade extending between the frame right side and the frame left side.

12. The method of mowing using a ground following trimmer of claim 11, wherein the second trimmer blade is adapted to operate by reciprocating motion along a second reciprocation axis that is:
offset from the first reciprocation axis in the depth direction; and
offset from the first reciprocation axis in the height direction.

13. The method of mowing using a ground following trimmer of claim 12, wherein
the height adjustment axis is substantially parallel to the width direction;
the roller axis is substantially parallel to the width direction;
the slider input axis is substantially parallel to the width direction;
the first reciprocation axis is substantially parallel to the width direction; and
the second reciprocation axis is substantially parallel to the width direction.

14. The method of mowing using a ground following trimmer of claim 13, wherein, during operation, the reciprocating motion of the first trimmer blade along the first reciprocation axis has an operating frequency and operating amplitude that is the same operating frequency and operating amplitude of the reciprocating motion of the second trimmer blade along the second reciprocation axis but wherein the reciprocating motion of the first trimmer blade 180 degree out of phase from the reciprocating motion of the second trimmer blade.

15. A ground following trimmer, comprising:
a frame defining a
a frame right side and a frame left side opposite from the frame right side and offset in a width direction by a frame width,
a frame front and a frame back opposite from the frame front and offset in a depth direction by a frame depth,
a frame top and a frame bottom opposite from the frame top and offset in a height direction by a frame height;
a first trimmer blade
extending between the frame right side and the frame left side, and
having a first trimmer blade adapted to operate by reciprocating motion along a first reciprocation axis that is substantially parallel to the width direction;
a height adjustment suspension having
a first slider-crank mechanism engaged with the frame at the frame right side, the first slider-crank having
a first crank defining
a first height adjustment axis about which the first crank is rotatably engaged to the frame, the first height adjustment axis being substantially parallel to the width direction,
a first roller axis offset from the first height adjustment axis by a first fixed crank distance, the first roller axis being substantially parallel to the width direction, and,
a first slider input axis offset from the first height adjustment axis by a second fixed crank distance, the first slider input axis being substantially parallel to the width direction,
a first slider having
a first slider end operatively engaged to the frame through a threadedly adjustable adjustment feature,
a second slider end operatively engaged to the crank at the first slider input axis to transmit work from the first slider to the first crank to rotate the first crank with respect to the frame about the first height adjustment axis, and
a grooming roller operationally engaged with the first slider-crank mechanism to rotate about the first roller axis and to provide support to the trimmer above a surface as the trimmer moves over the surface;
wherein rotation of the first crank about the first height adjustment axis changes the position of the first roller axis with respect to the frame in at least the height direction; and
wherein the first slider has a spring.

16. The ground following trimmer of claim 15, further comprising a mount adapted to operationally engage the ground following trimmer to an associated mower.

17. The ground following trimmer of claim 16, further comprising a second trimmer blade extending between the frame right side and the frame left side.

18. The ground following trimmer of claim 17, wherein the second trimmer blade is adapted to operate by reciprocating motion along a second reciprocation axis that is:
substantially parallel to the width direction;
offset from the first reciprocation axis in the depth direction; and
offset from the first reciprocation axis in the height direction.

19. The ground following trimmer of claim 18, wherein the slider further comprises a damper.

20. The ground following trimmer of claim 19, wherein, during operation, the reciprocating motion of the first trimmer blade along the first reciprocation axis has an operating frequency and operating amplitude that is the same operating frequency and operating amplitude of the reciprocating motion of the second trimmer blade along the second reciprocation axis but wherein the reciprocating motion of the first trimmer blade 180 degree out of phase from the reciprocating motion of the second trimmer blade.
